(19) United States
(12) Patent Application Publication
(10) Pub. No.: US 2016/0288735 A1
(43) Pub. Date: Oct. 6, 2016

(54) EXTERIOR ASSEMBLY AND METHOD FOR COUPLING AN EXTERIOR ASSEMBLY TO A VEHICULAR FRAME

(71) Applicant: Honda Motor Co., Ltd., Tokyo (JP)

(72) Inventors: Kurtis Horner, Marysville, OH (US); Edward Bach, Galloway, OH (US); Adam Rompage, Dublin, OH (US); Aron Madsen, Marysville, OH (US); Anthony Ordonio, JR., Dublin, OH (US)

(21) Appl. No.: 14/677,386

(22) Filed: Apr. 2, 2015

(51) Int. Cl. B60R 13/02; B62D 65/14; B62D 27/02

(52) U.S. Cl. CPC B60R 13/0243; B62D 27/026; B62D 65/14

(57) ABSTRACT

A vehicular door garnish assembly and methods of adhesively coupling the vehicular door garnish to the vehicular frame include a vehicular door garnish and an adhesive material applied to at least one of the vehicular door garnish and a portion of vehicular frame at least partially defining a door opening to couple the vehicular door garnish to the vehicular frame.

### BACKGROUND

The subject matter disclosed herein relates to automotive assemblies and methods for coupling automotive assemblies to a vehicular frame and, more particularly, to exterior vehicular assemblies and methods for coupling exterior vehicular assemblies to a vehicular frame using an adhesive material.

Presently, automobiles and other vehicles are typically assembled by processes involving multiple welding operations. In most processes, a vehicular frame is assembled by welding a plurality of metal frame pieces together to form the vehicular frame. Additionally, body panels, including door garnishes, which may be integral with the body panels, are typically welded to the vehicular frame. Upon completion of all welding steps, the entire assembled vehicle is electrocoated in a corrosive-resistant material. At this stage, the vehicular assembly is called a “white body.” The white body, including the welded exterior panels and door garnishes, is then suitable to receive paint and other bolt-on assemblies (e.g., doors, hood, trunk, and other non-welded body panels).

As mentioned above, in certain conventional processes, various exterior body panel assemblies, such as door garnishes, are bolted or clipped to the vehicular frame rather than welded to the vehicular frame. In these instances, it may be desirable to ensure these exterior body panel assemblies are easily removed, for example, for ease of replacement and/or service of underlying assemblies (e.g., replacement and/or service of engine parts or electrical parts).

Though suitable for some purposes, such assembly processes do not necessarily meet the needs of all application settings and/or users. For example, body panels and other exterior surface assemblies, such as door garnishes, may be constructed of materials that are not suitable for welding (e.g., carbon fiber, plastic, and/or glass materials). Additionally, in other settings, it may be desirable to paint body panels and other exterior surface assemblies, such as door garnishes, prior to coupling the body panel or exterior surface assembly to the vehicle frame. In such instances, welding is not a viable attachment means as it is not possible to weld non-metal materials and welding painted finished assembles destroys their appearance and corrosive-resistant coatings. Further, in other settings, bolt-on solutions often do not provide a stable or solid coupling means, which allows such bolted-on body panels or exterior surfaces to float and/or move. Thus, a solution is desirable that provides a versatile means of coupling assemblies of multiple various material types to the vehicular frame while ensuring a solid coupling.

### SUMMARY

In one embodiment, a vehicular door garnish assembly includes a vehicular door garnish and an adhesive material applied to the vehicular door garnish and/or a portion of a vehicular frame at least partially defining a door opening to couple the vehicular door garnish to the vehicular frame.

In another embodiment, a vehicle includes a vehicular frame having a portion at least partially defining a door opening and a vehicular door garnish. The vehicle also includes an adhesive material applied to the portion of the vehicular frame at least partially defining the door opening and/or the vehicular door garnish to couple the vehicular door garnish to the vehicular frame.

In another embodiment, a method for coupling a vehicular door garnish to a vehicular frame forming a door opening includes applying an adhesive material to a vehicular door garnish and/or a portion of a vehicular frame at least partially defining the door opening. The method further includes positioning the vehicular door garnish on the portion of the vehicular frame and curing the adhesive material to couple the vehicular door garnish to the portion of the vehicular frame.

### BRIEF DESCRIPTION OF THE DRAWINGS

FIG. 1 is a side view of a portion of an exemplary vehicle including a vehicular door garnish in accordance with various embodiments;

FIG. 2 illustrates the portion of the vehicle of FIG. 1 including a door in accordance with various embodiments;

FIG. 3 is a cross-sectional view of a vehicular frame and the vehicular door garnish in accordance with various embodiments; and

FIG. 4 is a detailed cross-sectional view of an interface between the vehicular frame and the vehicular door garnish in accordance with various embodiments.

The embodiments disclosed herein are not intended to limit or define the full capabilities of the disclosed assemblies and methods. It is assumed that the drawings and depictions constitute exemplary embodiments of the many embodiments of such assemblies and methods.

### DETAILED DESCRIPTION

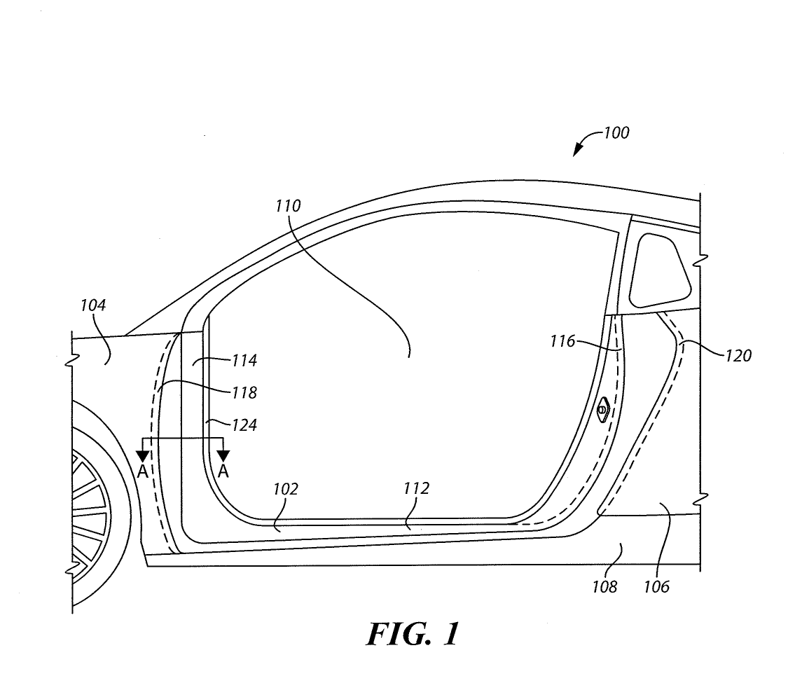

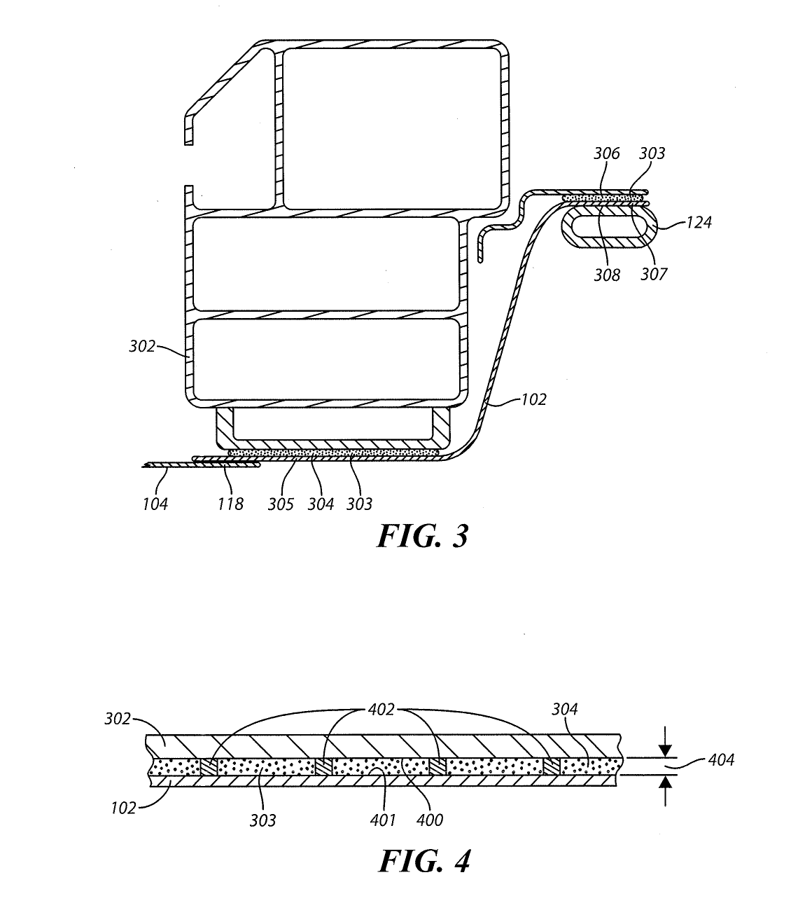

Referring now to the figures, FIG. 1 illustrates a side view of an exemplary vehicle 100. The vehicle 100 includes a vehicular frame 302 (shown in FIG. 3), a vehicular door garnish 102, and one or more exterior body panels or assemblies, such as a front quarter panel 104, a side outer panel 106, and a side valence assembly 108. The frame 302, which is hidden in the view of FIG. 1 by the exterior body panels 104, 106, 108, is manufactured by a process involving, at least in part, a plurality of welding operations to weld shaped sheet metal assembles (e.g., aluminum, steel, etc.) together to form the vehicular frame 302. Upon completion of the welding operations, the vehicular frame 302 can be electrocoated (or “e-coated”) in a known manner to apply a corrosion resistance layer to the vehicular frame 302. Upon completion of the electrocoating procedure, the vehicular frame 302 is called a “white body.” Typically, additional welding operations are avoided after the electrocoating procedure as any surface of the white body must be prepared for welding by grinding or sanding off the electrocoating layer to expose the metal underneath, which locations must be sealed once again after completion of these additional welding operations. Some components (e.g., doors, hood, trunk, etc.) are typically bolted on before the electrocoating procedure. However, in embodiments, these or other components may be bolted on after the electrocoating procedure, particularly if the components are magnesium, plastic, sheet moulding compound (SMC), or carbon fiber reinforced plastics (CFRP).

The vehicular door garnish 102, or door opening garnish, is the portion of the exterior skin of the vehicle 100 that is visible when the door is opened and is typically concealed from view when the door is closed. The vehicular door garnish 102 functions in part to cover the depth-wise or thickness-wise edges of the body of the vehicle 100 (for example, the thickness from the exterior surface to the interior surface) around the door opening 110. The vehicular door garnish 102 provides an aesthetically pleasing finish edge to the door opening 110 and also often provides additional surfaces to place various emblems, logos, warning stickers, informational plaques, and the like.

In a prior art vehicle assembly process, the vehicular door garnish 102 is formed as an integral portion of an exterior panel 104, 106, 108 (e.g., from the same sheet of metal). For example, in such previous processes, the vehicular door garnish 102 may be formed from multiple different portions of different exterior panels. A front portion may be formed as part of a front quarter panel 104, a rear portion may be formed as part of a side outer panel 106, and a lower portion may be formed as part of a side valence assembly 108. In such a prior art assembly process, the exterior panels 104, 106, 108, including the door garnish, are welded to the vehicular frame prior to the electrocoating process and are considered part of the white body. Upon completion of the electrocoating process, these exterior panels and door garnish can be painted to provide the final exterior painted surface.

In contrast, and according to various embodiments of this disclosure, the vehicular door garnish 102 is a separate assembly from the exterior panels 104, 106, 108. The vehicular door garnish 102 may be separate from the exterior panels 104, 106, 108 for any number of reasons, including a desire to utilize a material for the vehicular door garnish 102 that is distinct from that of the exterior panels. For example, the exterior panels 104, 106, 108 may be constructed from aluminum, steel, fiberglass, carbon fiber, molded plastic, or other suitable exterior materials. However, the vehicular door garnish 102 may be formed from a different material (including those listed above or other material types such as, for example, stainless steel). For example, the exterior panels 104, 106, 108 may be constructed of fiberglass while the vehicular door garnish 102 may be constructed of carbon fiber or aluminum.

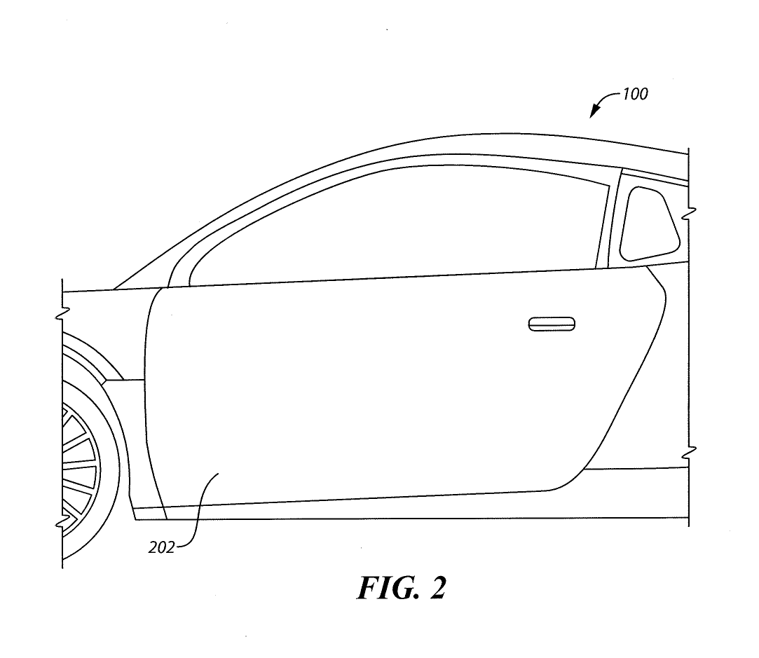

In certain embodiments, the vehicular door garnish 102 is a single piece substantially U-shaped assembly, though in other embodiments the vehicular door garnish 102 may include two, three, or more separate components. In some embodiments, the single piece assembly may be a single formed or molded assembly, or it may be constructed from a single piece of sheet metal. Alternatively, the single piece assembly may be constructed from multiple different pieces that are coupled together (e.g., via welding, a melting process, etc.) to form a single assembly prior to installation on the vehicle 100. In some embodiments, the vehicular door garnish 102 is pre-finished (e.g., painted) prior to being coupled to the vehicle 100. In some embodiments, the door garnish 102 includes a bottom sill portion 112 including a bottom sill surface that generally faces upward, a front portion 114 including a generally rearward-facing front surface (which forms an A-pillar portion in some embodiments), and a rear portion 116 including a generally forward-facing rear surface (which forms a B-pillar portion in some embodiments). The vehicular door garnish 102 defines the substantially U-shaped door opening 110 that is configured to receive a door 202 within the U-shaped opening, as is shown in FIG. 2. In some embodiments, a top of the vehicular door garnish 102 is approximately at the same height as a body portion of the door 202 (e.g., the portion of the door 202 below the glass of the door 202). In other embodiments, the vehicular door garnish 102 continues beyond a height of the body of the door 202, possibly up to the vehicle roof (for example, along the B-pillar) or along the windshield (for example, along the A-pillar).

In certain embodiments, the vehicular door garnish 102 is adhesively coupled to a portion of the vehicular frame 302 that is configured to receive the door garnish 102. As such, in certain embodiments, a method of installing a vehicular door garnish 102 within a portion of vehicular frame 302 includes applying a suitable adhesive material 303 to either (or both of) the vehicular door garnish 102 and/or the portion of the vehicular frame 302 configured to receive the vehicular door garnish 102. After the adhesive material 303 is applied, the vehicular door garnish 102 is positioned on or into the portion of the vehicular frame 302, after which the adhesive material 303 is cured to couple the door garnish 102 to the vehicular frame 302. In certain embodiments, the adhesive material 303 is allowed to cure over a suitable time period.

Turning now to FIG. 3, a cross-sectional view of the vehicular frame 302 and the vehicular door garnish 102 is provided. The exemplary cross-sectional view is shown from above looking downward at the front A-pillar portion, as is illustrated in FIG. 1 by the cross-section indication “A.” As described above, the portion of the vehicular frame 302 may include one or more features (e.g., one or more bends, surfaces, and/or curves), many of which are welded together. The vehicular frame 302 may include various surfaces configured to couple to the vehicular door garnish 102. The vehicular door garnish 102 is coupled to those surfaces by the adhesive material 303. In this example, two adhesive applications are provided to couple each edge (an outside edge 305 and an inside edge 307) of the vehicular door garnish 102 to the vehicular frame 302. In one embodiment, the adhesive material 303 is applied in a first adhesive application area or region 304 along or near the outside edge 305 of the vehicular door garnish 102, and in a second adhesive application area or region 306 on or near the inside edge 307 of the vehicular door garnish 102. In certain embodiments, the vehicular frame 302 is at least partially painted and/or electrocoated prior to coupling the vehicular door garnish 102 to the vehicular frame 302. In a particular embodiment, the vehicular frame 302 is entirely painted prior to coupling the vehicular door garnish 102 to the vehicular frame 302. Additionally or alternatively, the adhesive material 303 is applied in other suitable adhesive application areas or regions on the vehicular door garnish 102 and/or the vehicular frame 302.

In one embodiment, an outer body panel, such as the front quarter panel 104, is coupled to the exterior surface of the vehicular door garnish 102. In one embodiment, the outer body panel is coupled to the vehicular door garnish 102 using suitable clips or double-sided rubber tape, though other coupling methods are contemplated. Thus, in this embodiment, an overlap 118 is formed between the front quarter panel 104 and the vehicular door garnish 102 to allow for such coupling, as can be seen in FIG. 1. Similarly, an overlap 120 is formed between the side outer panel 106 and the vehicular door garnish 102, as is also shown in FIG. 1. A similar overlap is also formed between the vehicular door garnish 102 and the side valence assembly 108. Because the adhesive application areas 304, 306 provide a solid coupling between the vehicular frame 302 and the vehicular door garnish 102, the exterior body panels can be easily and securely attached to and removed from the vehicular door garnish 102. This is beneficial, for example, when service is best performed with exterior panels removed. Because it is not anticipated that service will be required behind or under the vehicular door garnishes 102, in one embodiment the adhesive application areas 304, 306 provide a permanent or semi-permanent installation of the door garnish 102 onto the vehicular frame 302 (e.g., not intended to be removed, or removable with an increased chance of damage to the vehicular door garnish 102). This ensures the coupling of the exterior body panels to the vehicle is solid and of suitable strength.

Similarly, because the adhesive application areas 304, 306 provide a solid and permanent or semi-permanent coupling, a door seal gasket 124 may be applied directly to an exterior surface of the vehicular door garnish 102 (e.g., a surface opposite the underside of the vehicular door garnish 102, being opposite the side that couples to the vehicular frame 302). The door seal gasket 124 is configured to interact with an inward-facing surface of the door to provide a seal between an interior and an exterior of the vehicle 100. The door seal gasket 124 is typically a compressible resilient rubber or foam, often being hollow in the middle to allow for compression, though other configurations are understood and utilized in the art. The door seal gasket 124 may be applied to the exterior surface of the vehicular door garnish 102 by any known method, including with double-sided adhesive tape, liquid adhesives, clips, screws, or other known coupling methods. As is shown in FIG. 3, the vehicular door garnish 102 is configured to receive the door seal gasket 124. In one embodiment, the vehicular door garnish 102 includes a feature 308 (e.g., bend or surface) that is specifically or partially intended to receive the door seal gasket 124. In a particular embodiment, the feature 308 includes a surface that is substantially perpendicular to an inward swing of the door 202 to ensure a proper compression of the door seal gasket 124.

In prior art applications, a door seal gasket is applied to an additional feature (e.g., bend or surface) of the vehicular frame that may extend beyond the door garnish rather than to the door garnish itself. This is because, in typical applications, the door garnish is not secure or stable enough to avoid movement (e.g., if it is secured by clips, bolts, etc.). In these prior art applications, if a door seal gasket were applied to the door garnish, such movement of the door garnish would translate to movement of the door seal gasket, thus creating gaps or breaks in the sealing between the interior and the exterior of the vehicle 100. Accordingly, in prior art applications, the door seal gasket is applied to the frame to prevent such movement. Conversely, and according to various embodiments described herein, the door seal gasket 124 is applied directly to the vehicular door garnish 102 without fear of the vehicular door garnish 102 moving and/or breaking the seal between the interior and the exterior of the vehicle 100. Accordingly, the additional feature often required as part of the vehicular frame to receive the door seal in prior art applications can be eliminated, thus, reducing the cost and complexity of the vehicular frame.

Further, by using the adhesive material 303 in the adhesive application areas 304, 306, the coupling process may be performed when access to only one side of the joining assemblies is accessible. For example, welding and riveting typically requires access to both sides of the assemblies. However, use of the adhesive material 303 in the adhesive application areas 304, 306 allows for setting or positioning the component, such as the vehicular door garnish 102, from one side and pressing it into proper position and alignment with the vehicular frame 302.

The adhesive material 303 may be applied by any suitable method. For example, in one embodiment, the adhesive material 303 is dispersed onto the underside surface 401 of the vehicular door garnish 102 and/or onto the vehicular frame 302 by any of the following methods: brushing, rolling, spraying, sputtering, extruding (e.g., squeezing the adhesive material 303 onto the desired surface), troweling, spreading, coating, using hot melt equipment, dip coating, using pre-formed adhesives, applying film adhesives, applying pressure-sensitive adhesives, and/or other known methods of applying adhesives. In some embodiments, an area to receive the adhesive material 303 is masked (e.g., with masking tape, plastic, paper, a stencil, etc.) to avoid application of the adhesive material 303 onto areas not intended to receive the adhesive material 303. The adhesive material 303 may be applied in one or more continuous or segmented strips, or it may be applied in a plurality of select locations along the areas where the vehicular door garnish 102 and the vehicular frame 302 are intended to be coupled. Other adhesive application patterns may be appropriate in a given setting.

In one embodiment, the adhesive material 303 is a permanent or semi-permanent adhesive. For example, in a particular embodiment, a suitable polyurethane adhesive is used. Polyurethane adhesives are typically flexible and durable while providing a tight and strong bond. Because a polyurethane adhesive is flexible, it can accommodate minor movements or impacts without cracking (e.g., while driving aggressively or over rough terrain, or upon impact with a shoe when a person is getting into or out of the vehicle 100, etc.). Further, polyurethane adhesives can generally accommodate thermal expansion between parts and imperfections in bonding surfaces. Exemplary polyurethanes include WS202FK or HAU140NS adhesives from YH America® of Versailles, Ky., 8500 adhesives from Ashland® of Covington, Ky., or other polyurethanes. Other adhesive materials 303 may be utilized in various embodiments, including, without limitation, urethane adhesives, epoxy adhesives, one-part adhesives, UV light curing adhesives, heat curing adhesives, moisture curing adhesives, multi-part adhesives, polyester resin adhesives, polyol adhesives, acrylic polymer adhesives, hot-melt adhesives, Ethylene-vinyl acetate adhesives, contact adhesives, Neoprene adhesives, pressure-sensitive adhesives, rubber cement adhesives, acrylate adhesives, superglue adhesives, anaerobic adhesives, cyanoacrylate adhesives, toughened acrylic adhesives, silicone adhesives, phenolic adhesives, polyimides adhesives, plastisol adhesives, or other suitable adhesive types not mentioned here. The adhesive material 303 may be in liquid, paste, calk, rubber, or other forms. The adhesive material 303 may be heated prior to or during application as needed. In certain embodiments, the adhesive material 303 is a viscous adhesive to allow the adhesive material 303 to flow to accommodate imperfect bonding surfaces (e.g., of the vehicular frame 302 and/or the vehicular door garnish 102) and to fill the space between the bonding surfaces. In certain embodiments, a curing agent may be utilized to aid in the curing process of the adhesive material 303, particularly in uncontrolled environments or environments that are not ideal for curing the particular adhesive material 303 (e.g., too dry, too humid, too hot, too cold, etc.).

In certain embodiments, the adhesive application areas 304, 306 are treated or prepared to receive the adhesive material 303. For example, the surfaces that are to be in contact with the adhesive material 303 may receive an adhesive primer prior to contact. Exemplary primers include RC50E, MS90, PC3, Gc20 GPI300, or VCFB primers from YH America® of Versailles, Ky.; Activator 205, 206, 209N, 215, 4300, 4900 primers from Sika® of Lyndhurst, N.J.; EF6000 and EF6001 primers from EFTEC® of Taylor, Mich.; Chemlok primers from Lord® of Cary, N.C.; or 08681 and other primers from 3M® of St. Paul, Minn. In some embodiments, the surfaces may require further preparation such as, for example, grinding or removing the electrocoat layer from the vehicular frame 302 or removing paint from the vehicular door garnish 102. In other embodiments, the vehicular door garnish 102 is masked prior to painting the vehicular door garnish 102 (which is painted prior to application to the vehicular frame 302 in certain embodiments) to prevent accidental application of paint or paint splatter to the adhesive application area 304, 306.

In one embodiment, upon completion of the adhesive coupling process, the adhesive application areas 304, 306 are the sole means of coupling the vehicular door garnish 102 to the vehicular frame 302. For example, it may not be necessary to also include various bolts, clips, and/or other attachment means to couple the vehicular door garnish 102 to the vehicular frame 302.

Turning now to FIG. 4, a detailed cross-sectional view of an interface between the vehicular frame 302 and the vehicular door garnish 102 is illustrated in accordance with various embodiments. The vehicular frame 302 is shown coupled to the vehicular door garnish 102 using a suitable the adhesive material 303 applied to the vehicular door garnish 102 and/or the vehicular frame 302 in the adhesive application areas 304 (or 306). In one embodiment, a plurality of standoffs 402 are provided between the surface 400 of the vehicular frame 302 and the undersurface 401 of the vehicular door garnish 102 to maintain a bond gap 404 therebetween. The bond gap 404 ensures space remains for the adhesive material 303 to reside between the two surfaces 400, 401. For example, the standoffs 402 maintain the bond cap 404 when pressure is applied before or during the cure cycle while the adhesive material 303 is still in its viscous state and liable to squeeze-out. The standoffs 402 may be disposed on the underside surface 401 of the vehicular door garnish 102 (being the surface 401 to be adhered to the vehicular frame 302). Alternatively, the standoffs 402 may be disposed on the surface 400 of the portion of the vehicular frame 302 that is to receive the vehicular door garnish 102. Alternatively still, the standoffs 402 may be disposed on or integrated as part of both surfaces. The standoffs 402 may be integrally molded, stamped, or formed portions of the vehicular door garnish 102, for example, that may be formed as part of the process to create the vehicular door garnish. Alternatively, the standoffs 402 may be subsequently added by a suitable method. The standoffs 402 may be welded to the surface 400 of the vehicular frame 302 or machined in some other known fashion. Alternatively, the standoffs 402 may be integrally molded, stamped, or otherwise formed as part of the formation process of the vehicular frame 302. In certain embodiments, the adhesive material 303 is applied to the surface 400 or 401 that includes the standoffs 402. For example, if the underside surface 401 of the vehicular door garnish 102 includes the standoffs 402, the adhesive material 303 may be applied thereto. Similarly, if the surface 400 of the vehicular frame 302 includes the standoffs 402, the adhesive material 303 may be applied thereto.

In certain embodiments, one or more alignment features are provided as part of the vehicular door garnish 102 and/or the vehicular frame 302. For example, one or both of the vehicular door garnish 102 and the vehicular frame 302 may include one or more slots, sockets, depressions, indentations, pockets, voids, gaps, or other receptacles, which are configured to receive or engage a corresponding member, tab, protrusion, projection, hump, nodule, prominence, or standoff (similar to standoffs 402 discussed above) provided on the opposite assembly. The alignment features may be created in a same or similar fashion as the standoffs 402 discussed above or by other processes. Corresponding alignment features are engageable to create a proper location fitting for the vehicular door garnish 102 on the vehicular frame 302 (e.g., left/right, forward/backward, and/or up/down).

Although there are benefits to using the adhesive material 303 to couple the vehicular door garnish 102 to the vehicular frame 302, certain considerations may be required. For example, the process of applying the adhesive material 303 to the vehicular door garnish 102 and/or the vehicular frame 302 should be performed with care so as to avoid squeeze-out of additional adhesive material 303 when set or positioned within the vehicular frame 302. This additional squeeze-out adhesive material can bond to other portions of the white body, which may be undesired. Also, special accommodations may be required in setting or positioning the vehicular door garnish 102 into the vehicular frame 302 to ensure a proper placement. For example, one or more jigs may be required to ensure proper placement and to ensure the vehicular door garnish 102 does not shift or twist. Additionally, one or more clamps may be required to apply pressure to prevent movement of the vehicular door garnish 102 within the vehicular frame 302 prior to and/or while the adhesive material 303 cures. Also, the process of applying the adhesive material 303 and setting the vehicular door garnish 102 may require maintenance of a particular environment (e.g., temperature and humidity) to ensure proper curing. Further, the processes of applying the adhesive material 303 and setting the vehicular door garnish 102 require additional time, and allowing the adhesive material 303 to cure requires time during which the vehicular door garnish 102 should not be touched or moved to ensure proper curing (which time may result in assembly down-time).

However, despite these extra considerations, the embodiments described herein provide a versatile means of coupling assemblies, possibly of multiple various material types, to the vehicular frame while ensuring a solid coupling. This allows for interchangeability of various exterior assemblies (e.g., vehicular door garnishes 102) constructed of various materials. For example, a graphite vehicular door garnish 102 may utilize the same assembly method as a carbon fiber vehicular door garnish 102. Additionally, exterior assemblies may be painted prior to application to the vehicle 100, which allows for a generally easier painting process and an easily customizable selection of differing colors for various portions of the vehicle 100.

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather, it is hereby intended the scope be defined by the claims appended hereto. Further, the word “exemplary” as used herein is to be understood as merely descriptive of an example and is not intended to connote preference or superiority to other examples described herein or to other modifications of the same. Additionally, the features of various implementing embodiments may be combined to form further embodiments of the disclosure.

1. A vehicular door garnish assembly comprising:
a vehicular door garnish; and
an adhesive material applied between the vehicular door garnish and a portion of a vehicular frame at least partially defining a door opening to couple the vehicular door garnish to the vehicular frame.

2. The vehicular door garnish assembly of claim 1 wherein the vehicular door garnish comprises a sill portion, an A-pillar portion, and a B-pillar portion.

3. The vehicular door garnish assembly of claim 1 wherein the vehicular door garnish comprises a single piece substantially U-shaped assembly comprising a bottom sill surface, a rearward-facing front surface, and a forward-facing rear surface.

4. The vehicular door garnish assembly of claim 3 wherein the vehicular door garnish defines a substantially U-shaped door opening for receiving a door.

5. The vehicular door garnish assembly of claim 1 further comprising:
a plurality of standoffs positioned on the portion of the vehicular frame, each of the plurality of standoffs configured to maintain a bond gap between the portion of the vehicular frame and the vehicular door garnish.

6. The vehicular door garnish assembly of claim 1 wherein the vehicular door garnish comprises a plurality of standoffs disposed on an underside surface of the vehicular door garnish configured to maintain a bond gap between the portion of the vehicular frame and the vehicular door garnish with the underside surface of the vehicular door garnish coupled to the portion of the vehicular frame by the adhesive.

7. The vehicular door garnish assembly of claim 1 further comprising a door seal gasket coupled directly to an exterior surface of the vehicular door garnish.

8. The vehicular door garnish assembly of claim 1 wherein the adhesive material comprises a polyurethane adhesive.

9. The vehicular door garnish assembly of claim 1 wherein the adhesive material comprises the sole means to couple the vehicular door garnish to the portion of the vehicular frame.

10. The vehicular door garnish assembly of claim 1 wherein the portion of the vehicular frame is at least partially painted.

11. A vehicle comprising
a vehicular frame having a portion at least partially defining a door opening;
a vehicular door garnish; and
an adhesive material applied between the portion of the vehicular frame at least partially defining the door opening and the vehicular door garnish to couple the vehicular door garnish to the vehicular frame.

12. The vehicle of claim 11 wherein the vehicular door garnish comprises a single piece substantially U-shaped assembly.

13. The vehicle of claim 11 wherein the adhesive material comprises the sole means of coupling the vehicular door garnish to the portion of the vehicular frame.

14. The vehicle of claim 11 wherein the vehicular door garnish and the portion of the vehicular frame are painted and the adhesive material couples the painted vehicular door garnish to the painted portion of the vehicular frame.

15. The vehicle of claim 11 wherein the vehicular door garnish includes a plurality of standoffs disposed on an undersurface of the vehicular door garnish, the plurality of standoffs configured to maintain a bond gap between the undersurface of the vehicular door garnish and the portion of the vehicular frame.

16. The vehicle of claim 11 further comprising a plurality of standoffs coupled to the vehicular frame to maintain a bond gap between the undersurface of the vehicular door garnish and the portion of the vehicular frame.

17. A method for coupling a vehicular door garnish to a vehicular frame forming a door opening, the method comprising:
applying an adhesive material to at least one of a vehicular door garnish and a portion of a vehicular frame at least partially defining the door opening;
positioning the vehicular door garnish on the portion of the vehicular frame; and
curing the adhesive material to couple the vehicular door garnish to the portion of the vehicular frame.

18. The method of claim 17 wherein applying the adhesive material to the at least one of the vehicular door garnish and the portion of the vehicular frame comprises applying the adhesive material to a surface comprising a plurality of standoffs for maintaining a bond gap between the vehicular door garnish and the portion of the vehicular frame.

19. The method of claim 17 further comprising clamping the vehicular door garnish to the portion of the vehicular frame prior to curing the adhesive material.

20. The method of claim 17 further comprising painting the vehicular door garnish prior to applying adhesive material to at least one of the vehicular door garnish and the portion of the vehicular frame and prior to setting the vehicular door garnish into the portion of the vehicular frame.

21. The method of claim 17 further comprising at least one of painting and electrocoating the vehicular frame prior to applying adhesive material to at least one of the vehicular door garnish and the portion of the vehicular frame and prior to setting the vehicular door garnish into the portion of the vehicular frame.
